(19) United States
(12) Patent Application Publication
(10) Pub. No.: US 2014/0137382 A1
(43) Pub. Date: May 22, 2014

(54) METHOD OF RETROFITTING AN AFTREATMENT SYSTEM

(71) Applicant: Caterpillar Inc., Peoria, IL (US)

(72) Inventor: Ken Stonecipher, Metamora, IL (US)

(73) Assignee: Caterpillar Inc., Peoria, IL (US)

(21) Appl. No.: 14/164,472

(22) Filed: Jan. 27, 2014

(51) Int. Cl. B60P 3/42

(52) U.S. Cl. CPC B60P 3/42
USPC 29/401.1

(57) ABSTRACT

A method of retrofitting an aftertreatment system of an engine is provided. The aftertreatment system includes a diesel particulate filter. The method includes removing a regeneration routine associated with a diesel particulate filter from an electronic control module of the engine. The method includes replacing the diesel particulate filter. The replacement includes removing the diesel particulate filter from the aftertreatment system. The replacement includes providing a housing at a location of the diesel particulate filter. The replacement includes proving a first end plate at an upstream end of the housing, and a second end plate at a downstream end of the housing. The replacement includes providing a plurality of hollow tubes between the first end plate and the second end plate. The replacement includes providing a plurality of cylindrical inserts adjacent to one another within at least one of the plurality of hollow tubes.

### TECHNICAL FIELD

The present disclosure relates to an aftertreatment system, and more particularly to a method of retrofitting the aftertreatment system.

### BACKGROUND

Aftertreatment systems, for treating emissions of an engine, are well known in the art. An aftertreatment system typically includes a diesel particulate filter (DPF) in addition to other emission treatment members. The DPF filters particulate matter present in exhaust gas of the engine.

The particulate matter trapped in the DPF is removed periodically by regeneration. Regeneration may involve using a heat source (not shown) to combust the particulate matter. The residual matter, present in the DPF after combustion, may have to be removed regularly. The removal of the residual matter may involve a recurring maintenance cost and down time. Further, the DPF may also have to be replaced regularly.

The DPF is typically provided to conform to emission requirements in certain jurisdictions. However, other jurisdictions may have less strict emission requirements such that the DPF is not an essential component for treatment of exhaust gas. In such jurisdictions, the DPF may therefore entail avoidable maintenance and/or replacement costs.

### SUMMARY

In one aspect of the disclosure, a method of retrofitting an aftertreatment system of an engine is provided. The aftertreatment system includes a diesel particulate filter. The method includes removing a regeneration routine associated with a diesel particulate filter from an electronic control module of the engine. The method also includes replacing the diesel particulate filter. The replacement includes removing the diesel particulate filter from the aftertreatment system. The replacement also includes providing a housing at a location of the diesel particulate filter. The replacement further includes proving a first end plate at an upstream end of the housing, and a second end plate at a downstream end of the housing. The replacement includes providing a plurality of hollow tubes between the first end plate and the second end plate. A number of the plurality of hollow tubes and a diameter of each of the plurality of hollow tubes are based on at least one operational parameter of the engine. The replacement further includes providing a plurality of cylindrical inserts adjacent to one another within at least one of the plurality of hollow tubes. Each of the plurality of cylindrical inserts includes a through passage oriented obliquely relative to a longitudinal axis of the cylindrical insert. A number of the plurality of cylindrical inserts and an angular orientation between adjacent cylindrical inserts are based on the at least one operational parameter of the engine.

Other features and aspects of this disclosure will be apparent from the following description and the accompanying drawings.

### BRIEF DESCRIPTION OF THE DRAWINGS

FIG. 1 illustrates a perspective view of a prior art aftertreatment system having a diesel particulate filter;

FIG. 2 illustrates a perspective view of the prior art aftertreatment system with the diesel particulate filter removed;

FIG. 3 illustrates a perspective view of the aftertreatment system including a device, according to an embodiment of the present disclosure;

FIG. 4 illustrates a partial sectional view of a first canister of the aftertreatment system showing hollow tubes of the device, according to an embodiment of the present disclosure;

FIG. 5 illustrates a partial sectional view of the first canister of the aftertreatment system showing cylindrical inserts inside the hollow tubes, according to an embodiment of the present disclosure;

FIG. 6 illustrates a detailed perspective view of the cylindrical inserts, according to an embodiment of the present disclosure;

FIG. 7 illustrates an end sectional view of the device, according to an embodiment of the present disclosure; and

FIG. 8 illustrates a flowchart depicting a method of retrofitting an aftertreatment system of an engine, according to an embodiment of the present disclosure.

### DETAILED DESCRIPTION

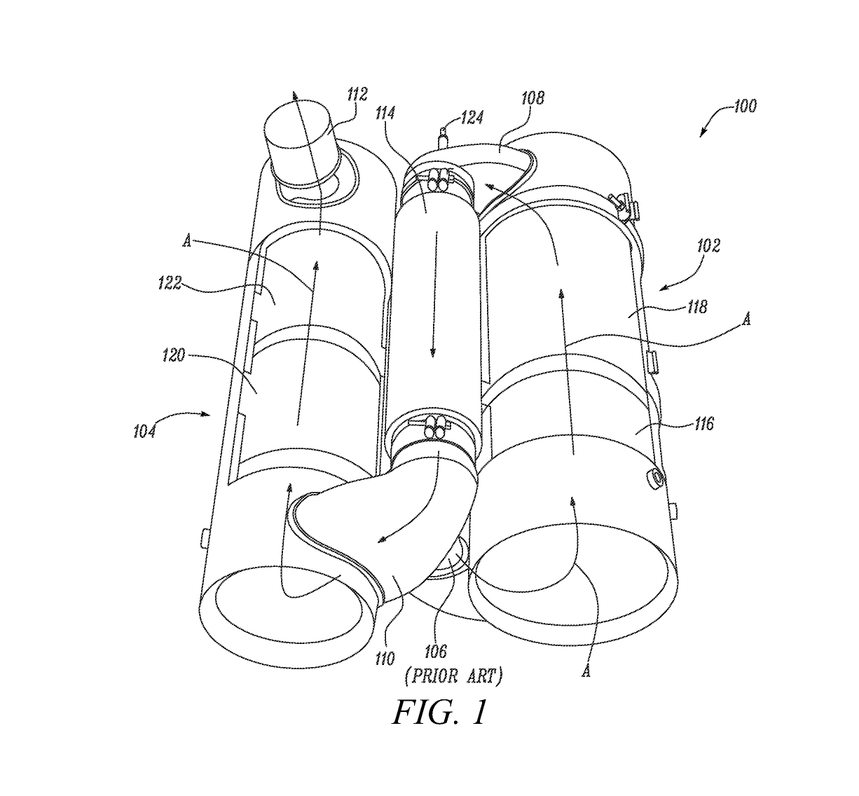

FIG. 1 illustrates a prior art aftertreatment system 100 for an engine (not shown). The prior art aftertreatment system 100 includes a first canister 102 and a second canister 104. The first canister 102 includes an inlet 106 and an outlet 108. Further, the second canister 104 includes a curved inlet 110 and an outlet 112. An intermediate tube 114 connects the outlet 108 of the first canister 102 to the curved inlet 110 of the second canister 104. The first canister 102 includes a diesel oxidation catalyst (DOC) 116 and a diesel particulate filter (DPF) 118. The second canister 104 includes a selective catalytic reduction (SCR) catalyst 120 and an ammonia oxidation (AMOX) catalyst 122. Further, an injector 124 is provided on the intermediate tube 114.

As shown by the arrows “A” in FIG. 1, an exhaust gas from the engine flows through the inlet 106 into the first canister 102, and then passes through the DOC 116 and the DPF 118. The DPF 118 may filter particulate matter present in the exhaust gas. The particulate matter trapped in the DPF 118 may be removed periodically by regeneration. Regeneration may involve using a heat source (not shown) to combust the particulate matter. An engine control module (ECM) of the engine may periodically actuate the heat source to regenerate the DPF 118. The ECM may include a regeneration routine stored in a memory for carrying out regeneration of the DPF 118. The residual matter, present in the DPF 118 after combustion, may have to be removed regularly.

As shown in FIG. 1, the exhaust gas exits the outlet 108 of the first canister 102 and enters the intermediate tube 114. The injector 124 injects a reductant into the exhaust gas. Subsequently, the exhaust gas enters the second canister 104 via the curved inlet 110, and passes through the SCR catalyst 120 and the AMOX catalyst 122. The reductant typically contains ammonia. The SCR catalyst 120, with the help of the reductant, reduces nitrous oxides (NOx) in the exhaust gas to nitrogen. The AMOX catalyst 122 may reduce an amount of unreacted ammonia from exiting the second canister 104. Finally, the exhaust gas exits the prior art aftertreatment system 100 through the outlet 112 of the second canister 104.

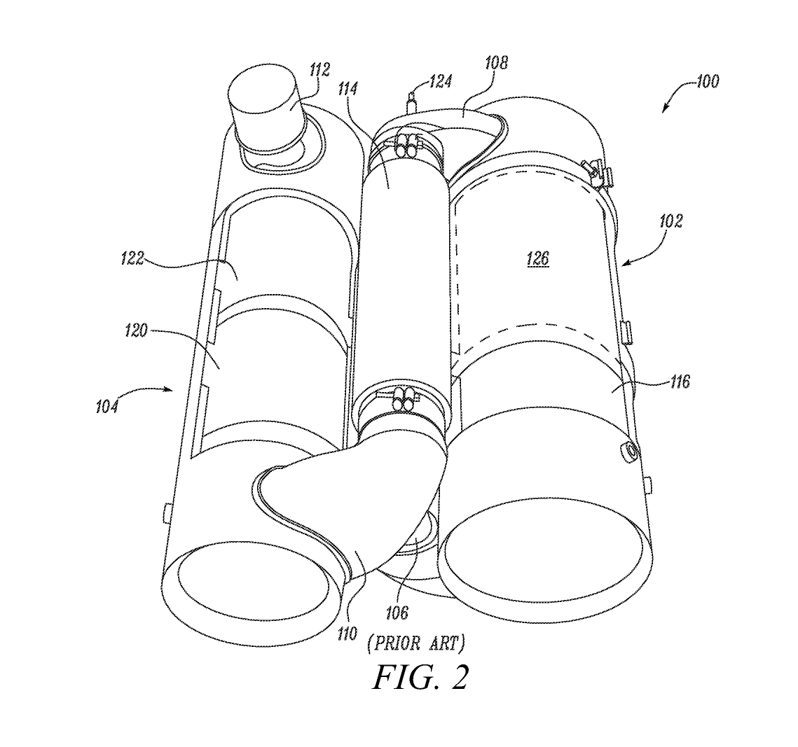

FIG. 2 illustrates the prior art aftertreatment system 100 with the DPF 118. A vacant space 126 is formed in the first canister 102 due to the removal of the DPF 118. The first canister 102 may include a door (not shown). The door may be opened to access an internal space of the canister 102 and remove the DPF 118.

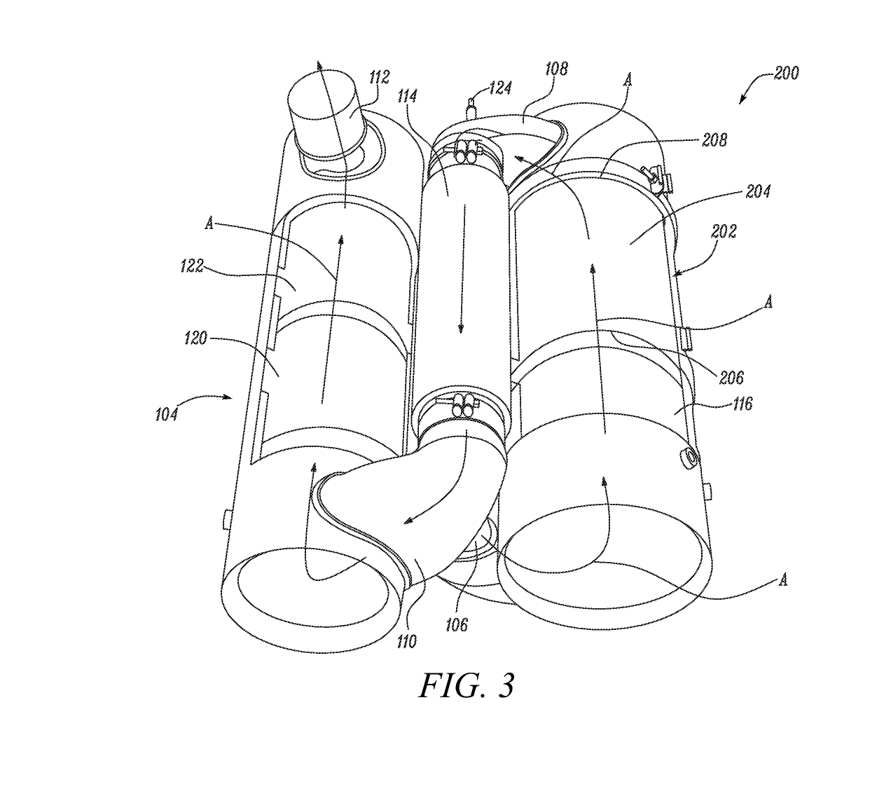

FIG. 3 illustrates an aftertreatment system 200, according to an embodiment of the present disclosure. Please note that elements of the aftertreatment system 200 that are common with the prior art aftertreatment system 100 have the same numbers. The aftertreatment system 200 is obtained by retrofitting the prior art aftertreatment system 100. Specifically, the DPF 118 of the prior art aftertreatment system 100 have been removed (shown in FIG. 2) and replaced with a device 202. The device 202 may be inserted through the door of the first canister 102. The device 202 is installed in the vacant space 126 (shown in FIG. 2). The door may be closed after installing the device 202. Further, the ECM may be reprogrammed to remove the regeneration routine associated with the DPF 118 of the prior art aftertreatment system 100. The device 202 includes a housing 204. As shown in FIG. 3, an upstream end 206 of the housing 204 is in fluid communication with the DOC 116, whereas a downstream end 208 of the housing 204 is in fluid communication with the outlet 108 of the first canister 102.

In an embodiment, various components of the device 202 may be assembled in situ within the first canister 102. In an alternative embodiment, the device 202 may already be assembled in the form of a kit, and the device 202 is provided at the vacant space 126 left by the DPF 118. Various details of the device 202 will be described hereinafter.

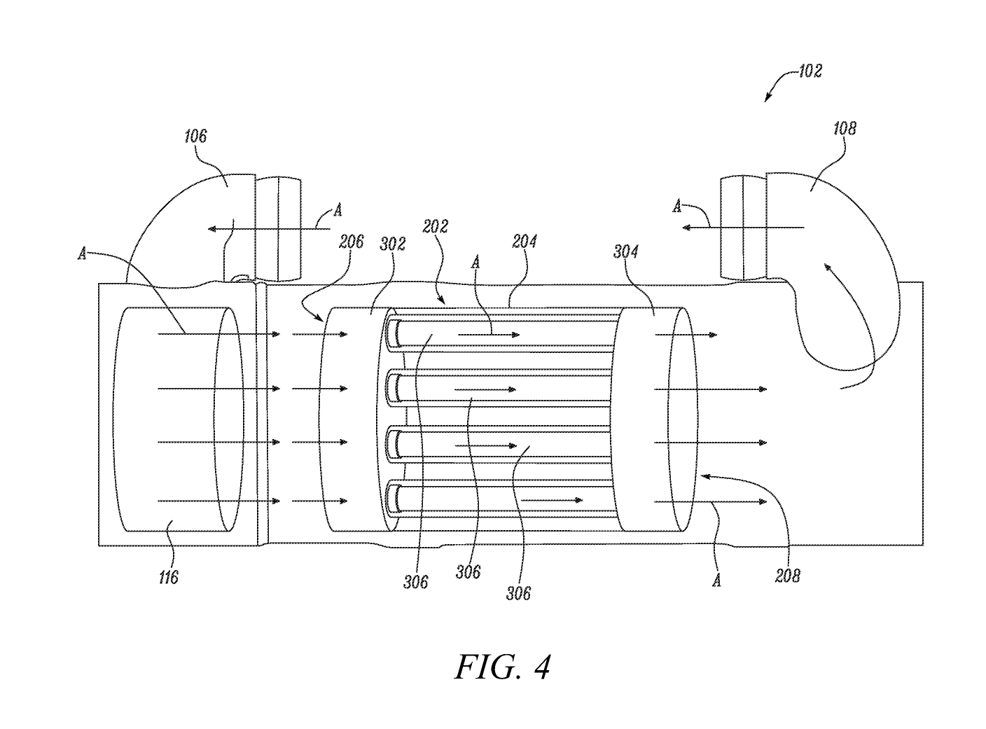

FIG. 4 illustrates a sectional view of the device 202 installed within the first canister 102, according to an embodiment of the present disclosure. The device 202 includes a first end plate 302 which is provided at the upstream end 206 of the housing 204. The first end plate 302 may interface with the DOC 116. Further, the device 202 includes a second end plate 304 which is provided at the downstream end 208 of the housing 204. Multiple hollow tubes 306 are provided are provided between the first and second end plates 302, 304. The hollow tubes 306 may be coupled to the first and second end plates 302, 304. In an embodiment, the first and second plates 302, 304 include multiple apertures (not shown) in fluid communication with the hollow tubes 306. The hollow tubes 306 may therefore fluidly communicate the apertures of the first end plate 302 to the apertures of the second end plate 304. As indicated by the arrows “A” in FIG. 4, the exhaust gas flows from the DOC 116 into the first end plate 302, through the hollow tubes 306, and subsequently through the second end plate 304. Finally, the exhaust gas flows out of the outlet 108 of the first canister 102.

The device 202, as shown in FIG. 4, is exemplary in nature, and the device 202 may be of various alternate configurations. For example, one or more support structures (not shown) may be provided between the first and second end plates 302, 304 in order to retain the hollow tubes 306 in place. Further, a number of the hollow tubes 306, shown in FIG. 4, are purely exemplary in nature. In an embodiment, a number of the hollow tubes 306 may be based on at least one operational parameter of the engine. The operational parameter may include, for example, but not limited to, a backpressure requirement of the engine, a sound attenuation requirement, and a flow rate of the exhaust gas. Further, a diameter of each of the hollow tubes 306 may be based on the at least one operational parameter of the engine. In an embodiment, a diameter of each of the hollow tubes 306 may lie in a range from about 10 mm to 20 mm. In a further embodiment, a length of each of the hollow tubes 306 may be about 80 mm. In various embodiments, the hollow tubes 306 may be made of a metal or a metallic alloy.

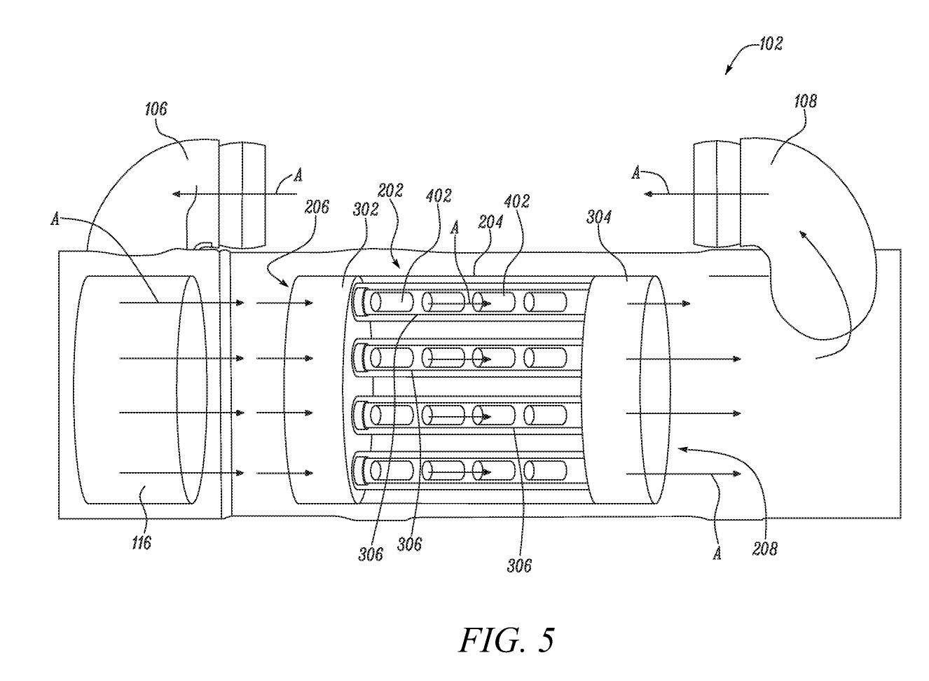

FIG. 5 illustrates multiple cylindrical inserts 402 provided adjacent to each other within each of the hollow tubes 306, according to an embodiment of the present disclosure. It may be contemplated that the cylindrical inserts 402 may be provided in only some of the hollow tubes 306. It may also be contemplated that multiple rows of the cylindrical inserts 402 may be provided within one or more hollow tubes 306 based on the dimensions of each of the cylindrical inserts 402. Further, the number of cylindrical inserts 402 provided in each of the hollow tubes 306 may vary based on the at least one operation parameter of the engine. A spacing between adjacent cylindrical inserts 402 may consequently vary. Further, a spacing between adjacent cylindrical inserts 402 may also vary along a length of one of the hollow tubes 306. In an embodiment, each of the cylindrical inserts 402 may be made of a ceramic material.

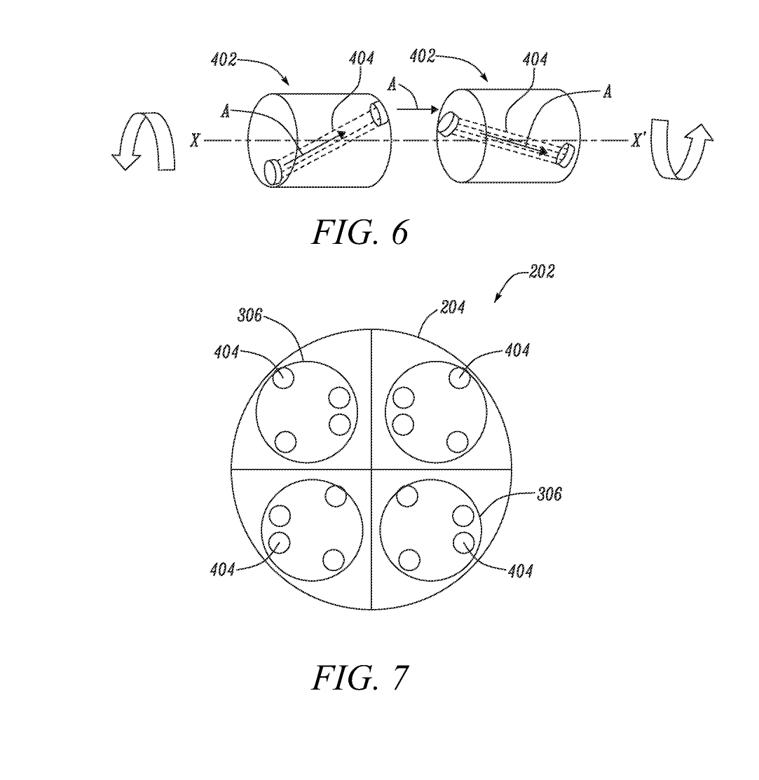

FIG. 6 illustrates two cylindrical inserts, according to an embodiment of the present disclosure. As shown in FIG. 6, each of the cylindrical inserts 402 includes a through passage 404. As indicated by the arrows “A”, the exhaust gas flows inside the through passages 404 of the cylindrical inserts 402. Further, the through passage 404 is oriented obliquely relative to a longitudinal axis X-X′ of each of the hollow tubes 306. In an embodiment, an angle between the through passage 404 and the longitudinal axis X-X′ may lie in a range from about 40 degrees to 45 degrees. Further, a length of each of the cylindrical inserts 402 along the longitudinal axis X-X′ may lie in a range from about 128 mm to 204 mm. In a further embodiment, an angular spacing between adjacent cylindrical inserts 402 may be based on the at least one operational parameter of the engine. As illustrated in FIG. 6, one of the cylindrical inserts 402 are rotated in a clockwise direction about the longitudinal axis X-X′. The other cylindrical insert 402 is rotated in a counter clockwise direction about the longitudinal axis X-X′. This may change an angular orientation between the through passages 404 since the through passages 404 are oriented obliquely relative to the longitudinal axis X-X′.

FIG. 7 illustrates a schematic end sectional view of the device 202 illustrating the various angular orientations between the through passages 404 of the cylindrical inserts 402, according to an embodiment of the present disclosure. The angular orientations may change for each of the hollow tubes 306, thereby providing multiple combinations. The number and rows of the cylindrical inserts 402 may provide additional variations. For example, one or more cylindrical inserts 402 may be provided within each of the hollow tubes 306. Further, the inserts 402 may be provided in one or more rows within each of the hollow tubes 306. These variations may permit multiple backpressure, sound attenuation and flow rate options.

### INDUSTRIAL APPLICABILITY

The prior art aftertreatment system 100, as shown in FIG. 1, includes the DOC 116, the DPF 118, the SCR catalyst 120, and the AMOX catalyst 122. The DPF 118 may filter particulate matter present in the exhaust gas. The particulate matter trapped in the DPF 118 may be removed periodically by regeneration. Regeneration may involve using a heat source (not shown) to combust the particulate matter. The residual matter, present in the DPF 118 after combustion, may have to be removed regularly. The removal of the residual matter may involve a recurring maintenance cost and down time. Further, the DPF 118 may also have to be replaced regularly. The DPF 118 may be typically provided to conform to emission requirements in certain jurisdictions. However, other jurisdictions may have less strict emission requirements such that the DPF 118 is not an essential component for treatment of the exhaust gas. In such jurisdictions, the DPF 118 may therefore entail avoidable maintenance and/or replacement costs.

The present disclosure is related to the aftertreatment system 200 including the device 202 in place of the DPF 118 of the prior art aftertreatment system 100. The aftertreatment system 200 may be used with various types of diesel engines. The diesel engines may be used in various types of machines, such as, but not limited to, excavators, bulldozers, powered shovels, trucks, cars, locomotives, and so on. The diesel engines may also be used for power generation and marine applications.

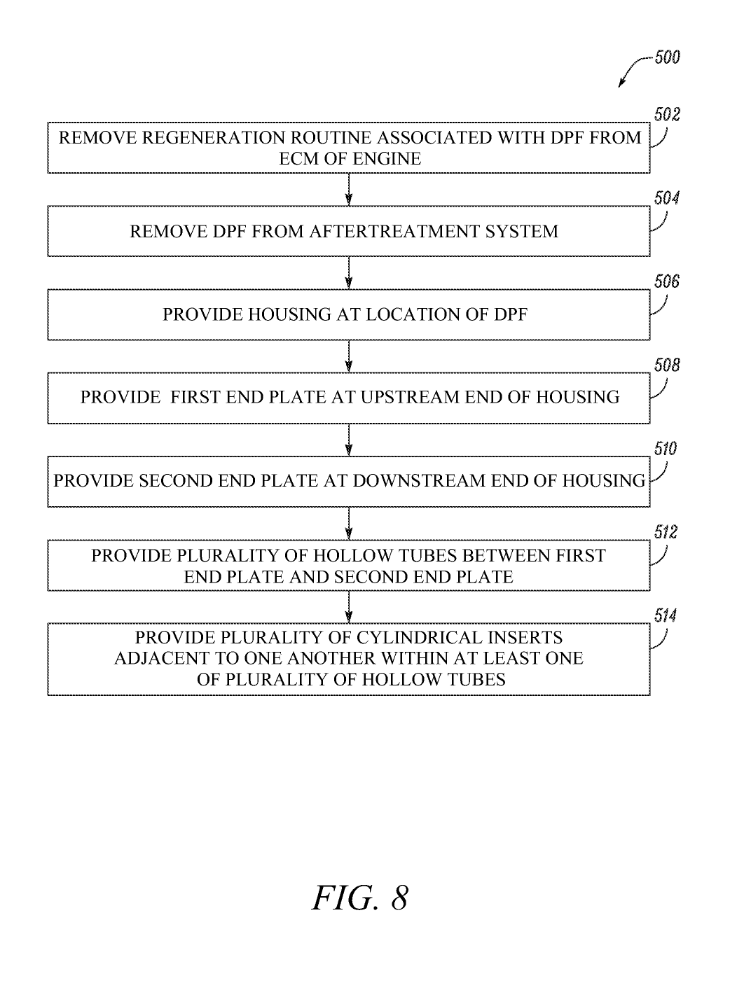

The present disclosure is also related to a method of retrofitting the prior art aftertreatment system 100 by replacing the DPF 118. FIG. 8 illustrates a flowchart showing the method 500, according to an embodiment of the present disclosure. Reference will be also made to FIGS. 1-7 for describing the method 500 in detail.

At step 502 of the method 500, the regeneration routine, associated with the DPF 118, is removed from the ECM of the engine. This may prevent the ECM from running the regeneration routine once the DPF 118 is replaced. The removal of the regeneration routine may involve reprogramming the ECM. At step 504, the DPF 118 is removed from the first canister 102 of the prior art aftertreatment system 100. The removal of the DPF 118 may result in a vacant space 126 (shown in FIG. 2) in the first canister 102. The DPF 118 may be removed from the first canister 102 by uncoupling the DPF 118 from the DOC 116 and/or any other part of the first canister 102.

At step 506, the housing 204 of the device 202 may be provided at location of the DPF 118. The location may correspond to the vacant space 126. The housing 204 may be coupled to the DOC 116 and/or any other part of the first canister 102. At step 508, the first end plate 302 is provided at the upstream end 206 of the housing 204. Further, at step 510, the second end plate 304 is provided at the downstream end 208 of the housing 204. In an embodiment, the first and/or second end plates 302, 304 may be attached to the housing 204.

Further, at step 512, the hollow tubes 306 are provided between the first and second end plates 302, 304. The hollow tubes 306 may be coupled to the first and second end plates 302, 304. The hollow tubes 306 may be in fluid communication with the apertures of the first and second end plates 302, 304 such that the exhaust gas may flow into the first end plate 302 from the DOC 116, through the hollow tubes 306, and then through the second end plate 304. In various embodiments, the number and the diameter of the hollow tubes 306 may be based on the at least one operational parameter of the engine.

At step 514, the cylindrical inserts 402 are provided adjacent to one another within at least one of the hollow tubes 306. Further, a number of the cylindrical inserts 402 may be based on the at least one operational parameter of the engine. The angular orientation between adjacent cylindrical inserts 402, and hence the angular orientation between the through passages 404 may also be based on the at least one operational parameter of the engine.

One or more steps 502 to 514 of the method 500, as described above, may occur simultaneously. Further, steps 502 to 514 may occur in any sequence. For example, the device 202 may already be assembled in the form of a kit before being installed within the first canister 102. Thus, steps 508 to 514 may be performed first and then steps 502 to 506. Alternatively, the device 202 may be assembled within the first canister 102 following the sequence of steps 502 to 514.

The device 202, installed by the method 500, may not require any further maintenance and/or replacement after installation. The device 202 may also be retrofitted with different types of engines having different operational parameters. For example, the number and diameter of the hollow tubes 306 may be varied to meet the different operational parameters. Further, the number of the cylindrical inserts 402 and the angular orientations between the through passages 404 of the cylindrical inserts 402 may also be varied. Therefore, the device 202 may provide multiple backpressure, sound attenuation and flow rate options. Specifically, the device 202 may provide a substitute for the DPF 118 in terms of backpressure, sound attenuation, flow rate and flow guidance of the exhaust gas.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of retrofitting an aftertreatment system of an engine, the aftertreatment system having a diesel particulate filter, the method comprising:
removing a regeneration routine associated with the diesel particulate filter from an electronic control module of the engine; and
replacing the diesel particulate filter, the replacement comprising:
removing the diesel particulate filter from the aftertreatment system;
providing a housing at a location of the diesel particulate filter;
providing a first end plate at an upstream end of the housing;
providing a second end plate at a downstream end of the housing; and
providing a plurality of hollow tubes between the first end plate and the second end plate, wherein a number of the plurality of hollow tubes and a diameter of each of the plurality of hollow tubes are based on at least one operational parameter of the engine; and
providing a plurality of cylindrical inserts adjacent to one another within at least one of the plurality of hollow tubes, wherein each of the plurality of cylindrical inserts comprises a through passage oriented obliquely relative to a longitudinal axis of the cylindrical insert, and wherein a number of the plurality of cylindrical inserts and an angular orientation between adjacent cylindrical inserts are based on the at least one operational parameter of the engine.
